(19) United States
(12) Patent Application Publication
(10) Pub. No.: US 2005/0140703 A1
(43) Pub. Date: Jun. 30, 2005

(54) Ink jet print head identification circuit and method

(76) Inventors: Hsiang-Pei Ou, Taichung City (TW); Jessen Chen, Caotun Township (TW); Jane Chang, Cyonglin Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/967,866

(22) Filed: Oct. 18, 2004

(30) Foreign Application Priority Data
Dec. 26, 2003 (TW) 92137026

(51) Int. Cl. B41J 29/38

(52) U.S. Cl. 347/5

(57) ABSTRACT

Ink jet print head identification circuit and method. A printer includes a controller, a printer carriage installed in the printer, and at least one print head set up in the printer carriage. Each print head is installed in the printer carriage, comprising an identification circuit coupled to the controller through a data line, a clock line and a latch line, wherein the identification circuit comprises a first storing unit, a first logic unit, a second logic unit, a second storing unit, and a bank driving circuit. By installing the first logic unit and the second logic unit, the print head doesn't need to feed back ID information to the controller of a printer, thus decreasing the loading of the controller.

### BACKGROUND

The invention relates to a print head, and more particularly, to print head utilized identification circuit in an ink jet printer.

Ink jet printers in all price ranges increasingly provide color printing capabilities. Typically, these printers include one print head for black ink printing, and at least one additional print head for printing multiple colors, such as magenta, cyan, and yellow. Print heads are replaceable and disposable, so that a new print head may be installed when the ink supply in the print head is depleted.

In many print head designs, the black and multicolor print heads are physically interchangeable, such that any type of print head may be installed in any available installation slot in the printer carriage. Since the format of print data provided to a black print head is generally different from the format of print data provided to a multicolor print head, the printer must be able to identify which type of print head is installed in each installation slot so that print data may be routed appropriately.

A conventional identification method installs an identification chip on a print head such that a printer can access and identify the print head method. Another method is to feed a bit in the data registers of the print head back to the controller of a printer for identification. The controller however must be utilized to identify the print head increasing load thereon.

In U.S. Pat. No. 5,940,095, John ,et al. discloses an identification circuit, wherein identification (ID) data is sequentially written from the operating system of a printer into registers of a print head through a specific ID line and CLK 1 and CLK 2 lines. The ID data is then sequentially fed back to the operation system for identification. If the feedback data does not correspond to the output from the operation system, it is determined that the print head is not compatible with the printer. This identification method, however, requires the described feedback process.

In U.S. Pat. No. 6,022,094, Gibson,et al. discloses another identification circuit, employing a memory matrix on a print head for providing various methods not confined to a sequences output ID data. The identification method, however still requires ID data to the operation system of a printer. Furthermore, the additional memory matrix in the print head requires additional costs memory space.

In U.S. Pat. No. 6,568,785, Edelen,et al. discloses another identification circuit. When print data is transferred into a print head, one bit of the print data is accessed by a controller of a printer for identification. In Edelen, a bit as ID data is inserted into the print data for the print head and is later fed back to the printer. The location of the bit in the print data is different for different print heads. This method however still requires ID data back to be fed back to the controller of a printer.

### SUMMARY

An embodiment of the invention provides a printer. The printer comprises a controller, a printer carriage, and at least one print head. Each print head is installed in the printer carriage, comprising an identification circuit coupled to the controller through a data line, a clock line and a latch line, wherein the identification circuit comprises a first storage unit, a first logic unit, a second logic unit, a second storage unit, and a bank driving circuit. The first storage unit stores n-bit data with m-bit ID data and n−m bit bank data, wherein the n-bit data is transferred from the data line, synchronized with a clock signal and transferred from the clock line. The first logic unit identifies whether the m-bit ID data output from the first logic unit meets a predetermined requirement. When the m-bit ID data does not meet the predetermined requirement, the second logic unit blocks a latch signal from the latch line, and, when the m-bit ID data meets the predetermined requirement, the second logic unit passes the latch signal. The second storage unit according to the latch signal passed from the second logic unit, latches and outputs the n−m bit bank data from the first storage unit. The bank driving circuit receives latched n−m bit bank data to accordingly drive corresponding bank lines.

An embodiment of the invention additionally provides an identification method, wherein the print head is installed in a printer. First, an n-bit data is stored in a storage unit of a printer, and includes m-bit ID data. Then, the m-bit ID data output from the storage unit is identifies whether the m-bit ID data output from the storage unit meets a predetermined requirement, when the m-bit ID data does not meet the predetermined requirement, a latch signal is blocked from the latch line. When the m-bit ID data meet the predetermined requirement, the latch signal is passed to a second storage unit. When the latch signal is passed, the n−m bit bank data from the first storage unit is latched and output. Finally, bank lines in the print head are driven according to latched n−m bit bank data.

A detailed description is given in the following with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic block diagram of a print head installed in a printer according to an embodiment of the invention;

FIG. 2 is a detailed circuit diagram according to FIG. 1;

FIG. 3 is a circuit diagram according to a second embodiment of the invention;

FIG. 4 is a circuit diagram according to a third embodiment of the invention; and

FIG. 5 is a circuit diagram according to a fourth embodiment of the invention.

### DETAILED DESCRIPTION

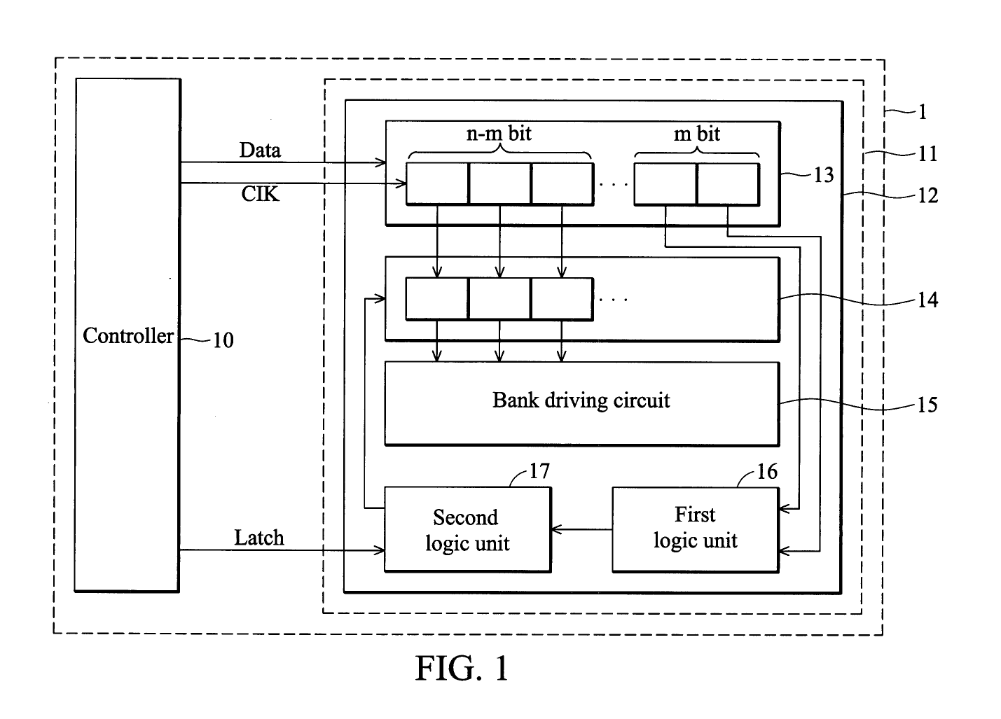

FIG. 1 is a schematic block diagram of a print head installed in a printer according to an embodiment of the invention. The printer 1 has a controller 10 and a printer carriage 11. A print head 12 is installed in the printer carriage 11 and the print head has an identification circuit with two storage units 13, 14 installed therein, a bank driving circuit 15, a first logic unit 16 and a second logic unit 17.

The controller 10 outputs control signals to the print head 12 in the print carriage 11. The control signals include data, clock and latch signals, respectively transmitted through a data line, a clock line and a latch line. Thus, the print head 12 has a data line (Data), a clock line (Clk), and a latch line (Latch) coupled to the controller 10. The storage unit 13 (first storage unit) has n-bit registers for storing n-bit data output from the data line (Data). In practice, the n-bit data synchronized with the clock signal on the clock line, and sequentially transferred into the n-bit registers of the storage unit 13 by the controller 10. N bits in the n-bit data are denoted as m-bit ID data. The remaining n−m bits of data are denoted as n−m bit bank data. The first logic unit 16 (ex: an m-bit AND gate) receives the m-bit ID data output from the storage unit 13, to identify whether the m-bit data meets a predetermined requirement. Compliance with this requirement indicates that the n-bit data can be properly printed by this print head 12. The second logic unit 17 (ex: an AND gate) receives the identification result from the first logic unit 16 and accordingly decides whether or not to pass the latch signal on the latch line (Latch). If the identification result is negative, the second logic unit 17 blocks the latch signal. Otherwise, the identification result is positive and the latch signal is passed to the storage unit 14. The storage unit 14 (second storage unit) has an n−m bit register, which latches and outputs the n−m bit bank data when the latch signal is received from the second logic unit 17. According to the output of the storage unit 14, the bank driving circuit 15 drives corresponding bank lines (not shown) for properly printing the data. When the storing unit 14 does not receive the latch signal, the storage unit 14 outputs no data to the bank driving circuit 15 and no printing occurs.

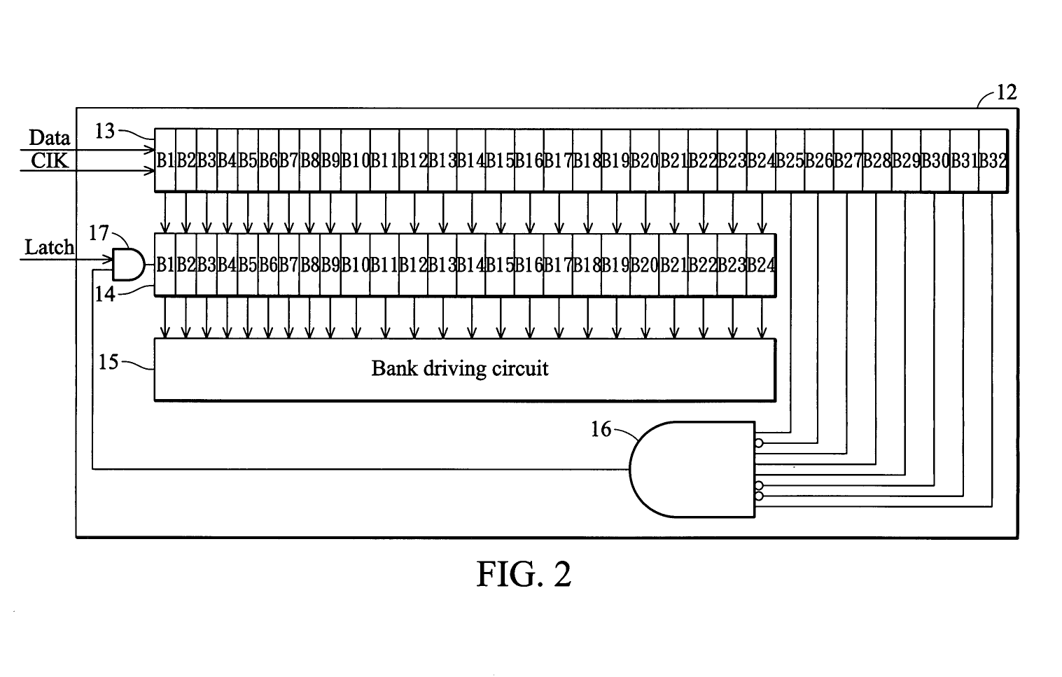

FIG. 2 is a detailed circuit diagram according to FIG. 1. In FIG. 2, the storage unit 13 has a 32-bit register for storing a 32-bit data block, in which the last 8 bits are ID data (m=8) The first logic unit 16 is an 8-bit AND gate which has 8 input terminals respectively connected to the 25th to 32nd registers, and 3 inverters located on the path to the 26th, 30th and 31st registers. The second logic unit 17 is an AND gate, which has two input terminals connected to the latch line (latch) and the output of the first logic unit 16. The storing unit 14 has a 24-bit register (n−m=24) for receiving the 24 bit bank data transferred from the storage unit 13.

In practice, the data is transferred sequentially into the registers of the storage unit 13 through data line (Data), synchronizing with the clock signal on the clock line (Clk) . The data stored in the 25th bit to the 32nd bit registers are ID data, so the 8 bit data is output to the first logic unit 16. Since the inverters are connected to the 26th, 30th and 31st registers of the storage unit 13, thus a logic 1 signal (first signal) is output from the first logic unit 16 only when the 8-bit ID data is the same as that shown in table 1. If the 8-bit ID data does not correspond to table 1, a logic 0 signal (second signal) is output from the first logic unit 16, which means the ID data does not match.

TABLE 1

| B25 | B26 | B27 | B28 | B29 | B30 | B31 | B32 |
|---|---|---|---|---|---|---|---|
| 1 | 0 | 1 | 1 | 1 | 0 | 0 | 1 |

When the first logic unit 16 outputs the logic 1 signal, the AND gate of the second logic unit 17 acts only as a buffer, passing every signal transmitted from the latch line. Thus, a latch signal such as a high level voltage on the latch line can be applied to the second logic unit 17 and to the storage unit 14, such that the 24-bit bank line data is output to the bank driving circuit 15. Conversely, when the first logic unit 16 outputs the logic 0 signal, the AND gate of the second logic unit 17 acts as a wall, fixing its output as a logic 0 signal regardless of the signal transmitted from the latch line such that the 24-bit bank data is not output.

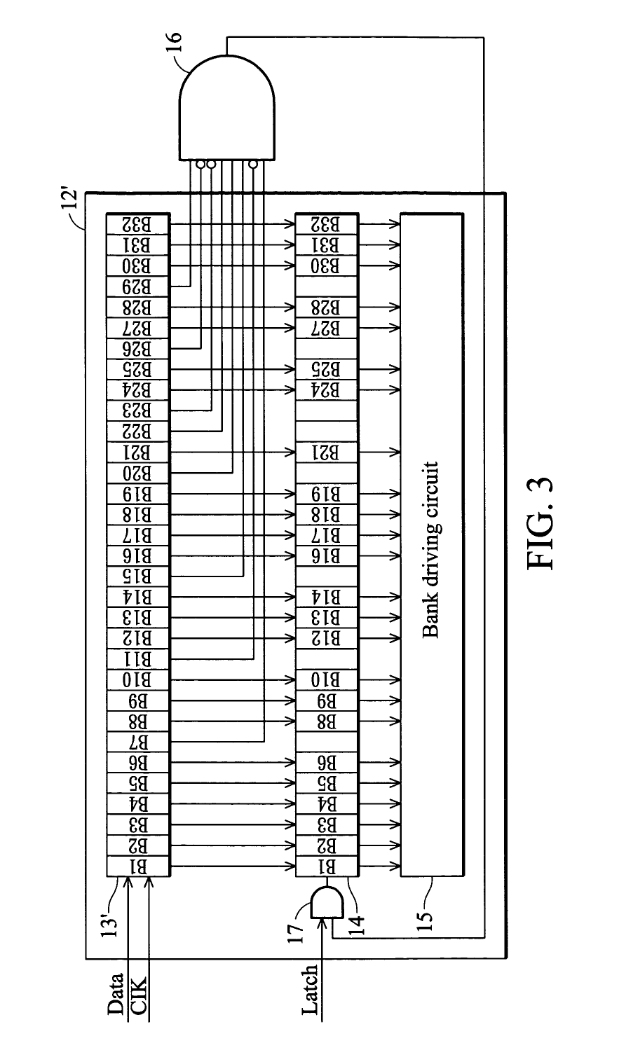

The m bits of the m-bit ID data need not be consecutively arranged in the n-bit data as shown in FIG. 2, but can be randomly arranged in the n-bit data. Taking FIG. 3 as an example, which is a circuit diagram in according to second embodiment, the 8 bit ID data are the 7th (B7), 11th (B11), 15th(B15), 20th(B20) 22nd (B22) 23rd (B23),26th(B26) and the 29th (B29) bits of the 32-bit data, while the remaining bits are the bank data.

The data is sequentially transferred into the registers of storage unit 13′ by data line (Data), and synchronized with the clock signal on the clock line (Clk). The data stored in the 7th(B7), 11th (B11), 15th (B15), 20th(B20), 22nd (B22),23rd (B23), 26th(B26) and the 29th (B29) bit registers are ID data, which are output to the first logic unit (AND gate) 16. If the 8-bit ID data is the same as that in table 2, a logic 1 signal (first signal) is output from the first logic unit 16. If the 8-bit ID data is not the same as that in table 2, a logic 0 signal (second signal) is output from the first logic unit 16. The other results are similar with those in FIG. 2 and not described again here.

TABLE 2

| B7 | B11 | B15 | B20 | B22 | B23 | B26 | B29 |
|---|---|---|---|---|---|---|---|
| 1 | 0 | 1 | 1 | 1 | 0 | 0 | 1 |

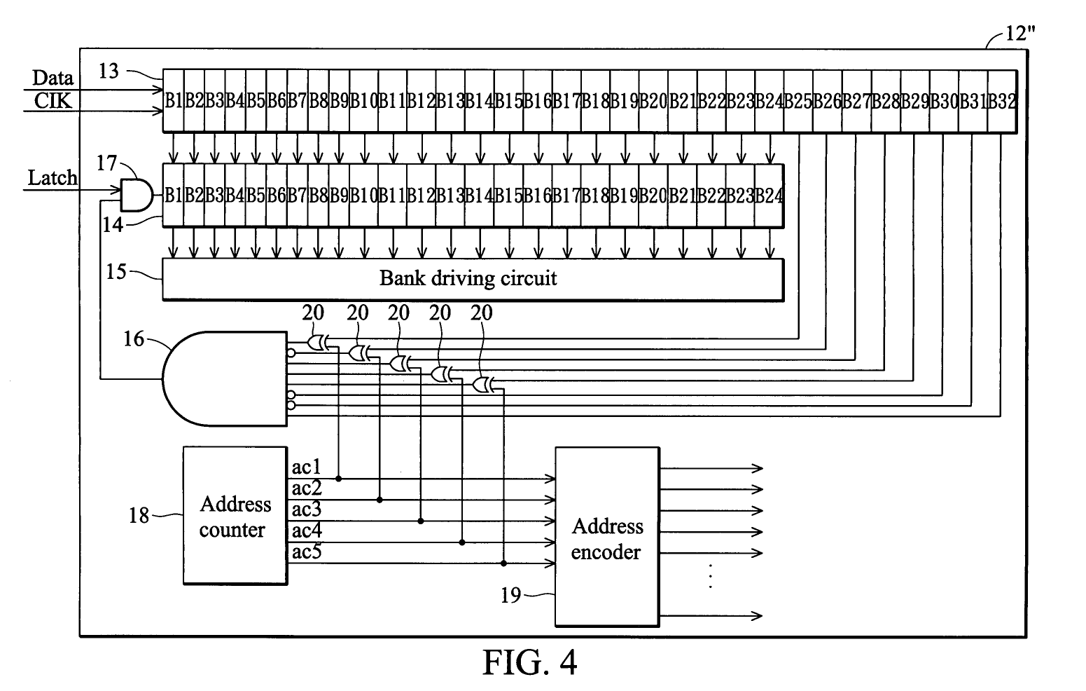

FIG. 4 is a circuit diagram according to another embodiment of the invention. Different from FIG. 2, in FIG. 4, shows an address counter 18, an address encoder 19 and several exclusive-ors (XORs) 20. The address counter 18 generates a 5-bit address and, through terminals ac1˜ac5, outputs it to the address encoder 19. One of the terminals ac1˜ac5 and a corresponding terminal in the 25th to 32nd registers (B25-B32) are coupled to a XOR (exclusive) gate 20, and the output thereof is connected to the logic unit 16.

The data, synchronized with the clock signal on the clock line (Clk) is transferred into the registers of storing unit 13′ by data line (Data) in sequence. The data stored in the 25th to 32nd registers (B25-B32) are ID data. The bit output from the 25th bit register and the bit output from the 1st terminal (ac1) is received by a XOR gate 20 and a XOR calculation result is accordingly generated. Similar results are also true for other XOR gates 20. In other words, all the XOR gates 20 determine whether the 5 bits of the registers B25-B29 have a predetermined relationship with the 5-bit address. This relationship shown in FIG. 4, is that the logic levels from the terminal acd and the bit register B25 are different, those from the terminal ac2 and the bit register B26 are the same, those from the terminal ac3 and the bit register B27 are different, those from the terminal ac4 and the bit register B28 are different, and those from the terminal ac5 and the bit register B29 are different. If the 8-bit ID data and the data output from the output terminals ac1˜ac5 comply with the rule as shown in table 3, a logic 1 signal is output from the AND gate of a first logic 16. Otherwise, a logic 0 signal (second signal) is output from the first logic unit 16. The other consequences are similar with those in FIG. 2 and not repeatedly described here.

TABLE 3

| B25 | B26 | B27 | B28 | B29 | B30 | B31 | B32 |
|---|---|---|---|---|---|---|---|
| 1/0 | 0/1 | 1/0 | 1/0 | 1/0 | 0 | 0 | 1 |
| Ac1 | ac2 | ac3 | ac4 | Ac5 | | | |
| 0/1 | 0/1 | 0/1 | 0/1 | 0/1 | | | |

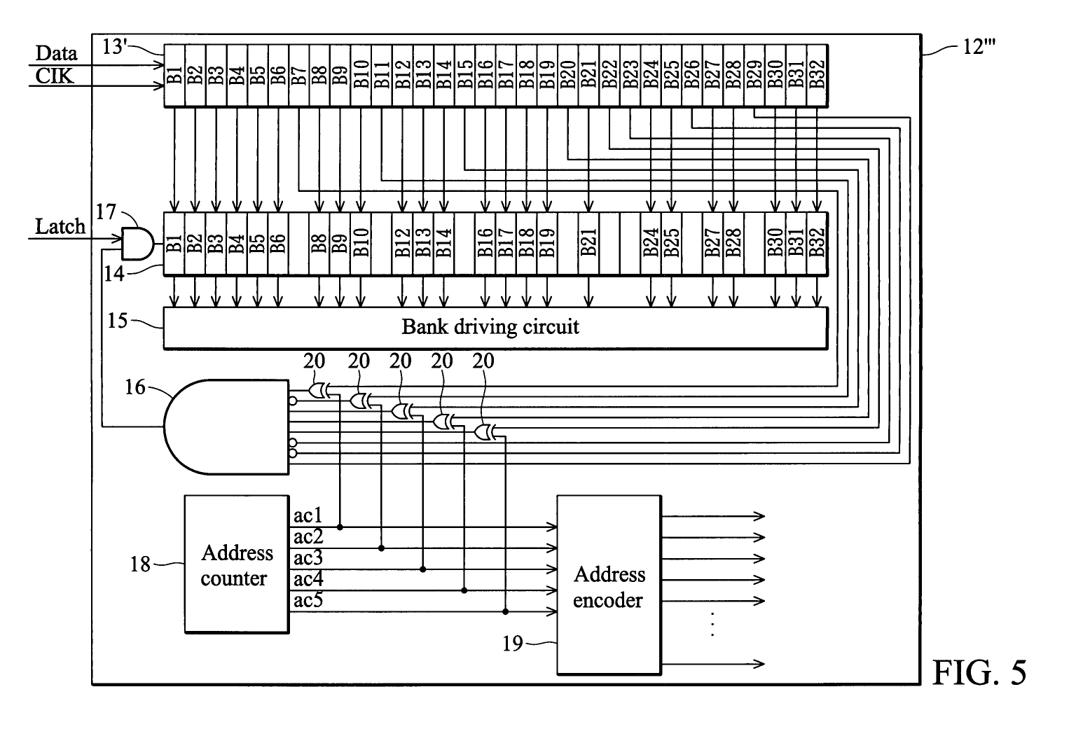

FIG. 5 is a circuit diagram in according to a fourth embodiment of the invention. The 5 bits of the 5-bit ID data need not be consecutively arranged in the n-bit data as shown in FIG. 4, but can be randomly arranged in the n-bit data. In FIG. 5, the 8 bit ID data are the 7th (B7), 11th (B11), 15th(B15), 20th(B20),22nd (B22),23rd (B23), 26th(B26) and the 29th (B29) bits of the 32-bit data, and other bits are bank data.

Since FIG. 5 is similar with both FIG. 3 and FIG. 4, those skilled in the art can easily deduce the operations in FIG. 5 according to FIGS. 3 and 4. The rule for proper printing of the 32-bit data listed in table 4 and description the detail operations of FIG. 5 omitted herein.

TABLE 4

| B7 | B11 | B15 | B20 | B22 | B23 | B26 | B29 |
|---|---|---|---|---|---|---|---|
| 1 | 0 | 1 | 1 | 1 | 0 | 0 | 1 |
| Ac1 | ac2 | ac3 | ac4 | Ac5 | | | |
| 0 | 0 | 0 | 0 | 0 | | | |

The invention provides a method and apparatus for ink jet print head identification requiring no feed back of ID information to the controller of a printer, thus decreasing load on the controller. The operation of the system using the print head of the present invention is more efficient and more secure. Moreover, no extra memory matrix is required, thus reducing the circuit area and cost.

While the invention has been described by way of example and in terms of preferred embodiment, it is to be understood that the invention is not limited thereto. On the contrary, it is intended to cover various modifications and similar arrangements as would be apparent to those skilled in the art. Therefore, the scope of the appended claims should be accorded the broadest interpretation to encompass all such modifications is and similar arrangements.

1. A printer, comprising:
a controller;
a printer carriage; and
at least one print head, installed in the printer carriage, comprising an identification circuit coupled to the controller through a data line, a clock line and a latch line, wherein the identification circuit comprises:
a first storing unit storing n-bit data with m-bit ID data and n−m bit bank data, wherein the n-bit data is transferred from the data line, synchronizing with clock signal transferred from the clock line;
a first logic unit identifying whether the m-bit ID data outputted from the first logic unit meets a predetermined requirement;
a second logic unit, when the m-bit ID data does not meet the predetermined requirement, blocking a latch signal from the latch line, and, when the m-bit ID data meet the predetermined requirement, passing the latch signal;
a second storing unit, according to the latch signal passed from the second logic unit, latching and outputting the n−m bit bank data from the first storing unit; and
a bank driving circuit receiving latched n−m bit bank data to accordingly drive corresponding bank lines.

2. The printer as claimed in claim 1, wherein the first storing unit comprises n-bit registers for storing the n-bit data.

3. The printer as claimed in claim 1, wherein the m bits of the m-bit ID data are consecutively or randomly arranged in the n-bit data.

4. The printer as claimed in claim 1, wherein the first logic unit is an m-bit AND gate.

5. The printer as claimed in claim 1, wherein the second logic unit is an AND gate.

6. The printer as claimed in claim 1, wherein the second storing unit comprises n−m bit registers.

7. The printer as claimed in claim 1, further comprising:
an address counter, generating a k bit address; and
k number of third logic units, determining whether the k bit address and k bits in the m-bit ID data meet a second requirement.

8. A print head, coupled to a controller through a data line, a clock line and a latch line, comprising an identification circuit comprising:
a first storing unit storing n-bit data with m-bit ID data and n−m bit bank data, wherein the n-bit data is transferred from the data line, synchronizing with clock signal transferred from the clock line;
a first logic unit identifying whether the m-bit ID data outputted from the first logic unit meets a predetermined requirement;
a second logic unit, when the m-bit ID data does not meet the predetermined requirement, blocking a latch signal from the latch line, and, when the m-bit ID data meet the predetermined requirement, passing the latch signal;
a second storing unit, according to the latch signal passed from the second logic unit, latching and outputting the n−m bit bank data from the first storing unit; and
a bank driving circuit receiving latched n−m bit bank data to accordingly drive corresponding bank lines.

9. The printer as claimed in claim 8, wherein the first storing unit comprises n-bit registers for storing the n-bit data.

10. The print head as claimed in claim 8, wherein the m bits of the m-bit ID data are consecutively or randomly arranged in the n-bit data.

11. The print head as claimed in claim 8, wherein the first logic unit is an m-bit AND gate.

12. The print head as claimed in claim 8, wherein the second logic unit is an AND gate.

13. The print head as claimed in claim 8, wherein the second storing unit comprises n−m bit registers.

14. The print head as claimed in claim 8, further comprising:
an address counter, generating a k bit address; and
k number of third logic units, determining whether the k bit address and k bits in the m-bit ID data meet a second requirement.

15. A method with ability of print head identification, comprising:
a. storing an n-bit data into a storing unit of a print head of a printer, wherein the n-bit data includes m-bit ID data;
b. in the print head, identifying whether the m-bit ID data outputted from the first logic unit meets a predetermined requirement;
c. when the m-bit ID data does not meet the predetermined requirement, blocking a latch signal from the latch line;
d. when the m-bit ID data meet the predetermined requirement, passing the latch signal to a second storing unit;
e. when the latch signal is passed, latching and outputting the n−m bit bank data from the first storing unit; and
f. driving bank lines in the print head according to latched n−m bit bank data.

16. The method as claimed in claim 15, wherein the storing unit has n-bit registers for storing the n-bit data.

17. The method as claimed in claim 16, wherein the step of storing is to consecutively or randomly store the n-bit data into the n-bit registers.

18. The method as claimed in claim-15, wherein the step of identifying further comprises the following steps:
generating a k-bit address; and
determining whether the k-bit address and k bits in the m-bit meet a second requirement.
